(19) United States
(12) Patent Application Publication
(10) Pub. No.: US 2026/0169020 A1
(43) Pub. Date: Jun. 18, 2026

(54) IMAGE FORMING DEVICE

(71) Applicant: Takahide Kenmotsu, Numazu Shizuoka (JP)

(72) Inventor: Takahide Kenmotsu, Numazu Shizuoka (JP)

(73) Assignee: ETRIA CO., LTD., Kanagawa (JP)

(21) Appl. No.: 19/262,515

(22) Filed: Jul. 8, 2025

(30) Foreign Application Priority Data
Dec. 18, 2024 (JP) 2024-222334

(51) Int. Cl. G01P 3/36; B41J 13/03; B41J 29/393; G03G 15/00

(52) U.S. Cl. CPC G01P 3/36; B41J 13/03; B41J 29/393; G03G 15/55; G03G 15/6529

(57) ABSTRACT

There is provided an image forming device capable of detecting whether or not a foreign matter is adhering to an optical rotary encoder while suppressing a decrease in user convenience. An image forming device includes an optical rotary encoder, a DC motor, and a control unit. The optical rotary encoder has a code wheel. The optical rotary encoder is attached to the DC motor. The control unit controls the DC motor. In addition, the control unit acquires target speed information representing a target speed for a speed corresponding to a rotational speed of the DC motor and detects whether or not a foreign matter is adhering to the code wheel based on the acquired target speed information.

### BACKGROUND OF THE INVENTION

### Field of the Invention

An embodiment of the present invention relates to an image forming device.

Priority is claimed on Japanese Patent Application No. 2024-222334, filed Dec. 18, 2024, the content of which is incorporated herein by reference.

### Description of Related Art

Conventionally, image forming devices including an optical rotary encoder are known.

### Patent Documents

[Patent Document 1] Japanese Unexamined Patent Application, First Publication No. 2010-213424

### SUMMARY OF THE INVENTION

Here, in an image forming device as described in Patent Document 1, in a case in which a foreign matter adheres to an optical rotary encoder in a manufacturing process, the foreign matter is detected in an inspection process. However, the detection of foreign matter in such the inspection process is a means dedicated for a manufacturing process, and foreign matter adhering to the optical rotary encoder during a user's use of the image forming device cannot be detected. On the other hand, in the case of a method in which an image forming device is operated in a foreign matter detection mode for detecting whether or not foreign matter has adhered to an optical rotary encoder, there is a problem that printing cannot be performed during execution of the foreign matter detection mode. This leads to reduction of a user's convenience, which is not desirable.

An object to be achieved by the present invention is to provide an image forming device capable of detecting whether or not foreign matter has adhered to an optical rotary encoder while inhibiting reduction of a user's convenience.

### Solution to Problem

An image forming device according to an embodiment includes an optical rotary encoder, a DC motor, and a control unit. The optical rotary encoder has a code wheel. The optical rotary encoder is attached to the DC motor. The control unit controls the DC motor. In addition, the control unit acquires target speed information representing a target speed for a speed corresponding to a rotational speed of the DC motor and detects whether or not a foreign matter is adhering to the code wheel based on the acquired target speed information.

### BRIEF DESCRIPTION OF THE DRAWINGS

FIG. 1 An external view illustrating an example of the overall configuration of an image forming device 100 according to an embodiment.

FIG. 2 A diagram illustrating an example of a DC motor included in the image forming device 100.

FIG. 3 An enlarged top view of a code wheel H illustrated in FIG. 2.

FIG. 4 A diagram illustrating an example of a pulse signal.

FIG. 5 A diagram illustrating an example of a view of a code wheel H to which a foreign matter, which is large enough to cover a foreign matter adhesion slit, is adhering.

FIG. 6 A diagram illustrating an example of a pulse signal of a case in which an object OA is adhering to the foreign matter adhesion slit as illustrated in FIG. 5.

FIG. 7 A diagram illustrating an example of a view of the code wheel H to which a foreign matter that is small enough to cover only a part of the foreign matter adhesion slit is adhering.

FIG. 8 A diagram illustrating an example of a pulse signal of a case in which an object OB is adhering to the foreign matter adhesion slit as illustrated in FIG. 7.

FIG. 9 A diagram illustrating an example of the functional configuration of the image forming device 100.

FIG. 10 A diagram illustrating an example of the flow of a process in which the image forming device 100 calculates a judgment threshold value.

FIG. 11 A diagram illustrating an example of the flow of a process in which the image forming device 100 detects whether or not a foreign matter is adhering to an optical rotary encoder E.

FIG. 12 A diagram for describing a speed stability section. A horizontal axis of a graph illustrated in FIG. 12 represents an elapsed time.

### DETAILED DESCRIPTION OF THE INVENTION

An image forming device according to an embodiment will be described with reference to the drawings. In the drawings, the same reference signs are attached to the same components. As an example of the image forming device according to the embodiment, an image forming device 100 is described as an example.

### Details of Image Forming Device

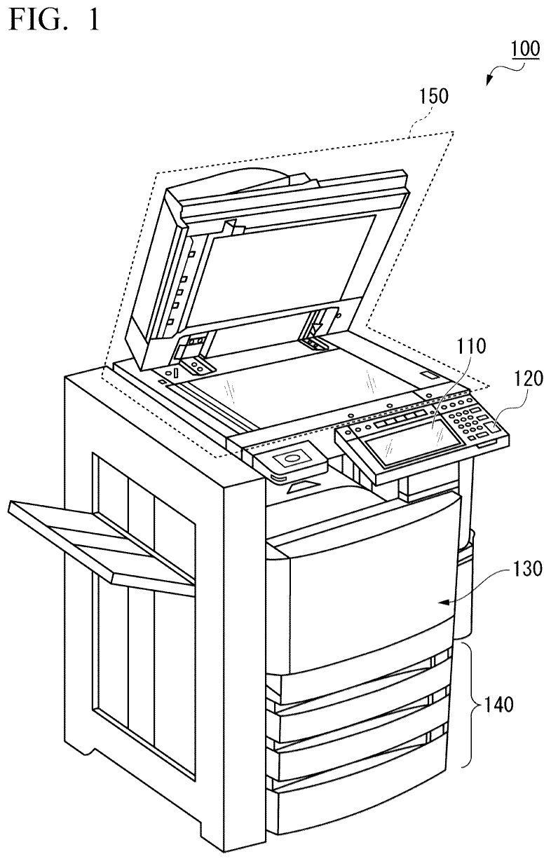

Details of the image forming device 100 are described with reference to FIG. 1.

FIG. 1 is an external view illustrating an example of the overall configuration of an image forming device 100 according to an embodiment. The image forming device 100 may be any device, as long as it is a device that includes various types of DC motors and can form an image on a print medium. In the example illustrated in FIG. 1, the image forming device 100 is, for example, a multifunction machine that performs image processing of a scanner, a facsimile, and the like together with forming images on print media but is not limited thereto. The image processing is processing relating to images. The image processing, for example, is processing of reading image information of a reading target, processing of recording (storing) image information, processing of transmitting an image to another device, and the like. Printing media may be any media as long as they are sheet-like media and, for example, are printing paper, seal mounts, and the like, but are not limited thereto.

The image forming device 100 includes a display 110, a control panel 120, a printer unit 130, a print media housing unit 140, and an image reading unit 150. The printer unit 130 of the image forming device 100 may be a device that fixes toner images or may be an inkjet-type device.

The image forming device 100 generates digital data by reading an image that appears on a reading target and produces an image file. The reading target may be any medium as long as it is a sheet-like medium and, for example, it is a paper sheet or the like on which a manuscript, text, images, and the like are written.

The display 110 is an image display device such as a liquid crystal display, an organic electroluminescence (EL) display, or the like. The display 110 displays various kinds of information about the image forming device 100.

The control panel 120 has multiple buttons. The control panel 120 receives a user's operation. The control panel 120 outputs signals in response to operations performed by the user to the control unit of the image forming device 100. The display 110 and the control panel 120 may be configured as an integrated touch panel.

The printer unit 130 forms an image on a print medium based on image information generated by the image reading unit 150 or image information received via a communication path. The printer unit 130, for example, forms an image using the following process. The image forming unit of the printer unit 130 forms an electrostatic latent image on a photoconductor drum based on image information. The image forming unit of the printer unit 130 forms a visible image by causing a developer to adhere to an electrostatic latent image. An example of the developer is toner. A transfer unit of the printer unit 130 transfers a visible image onto a print medium. The fixing unit of the printer unit 130 fixes a visible image onto a print medium by heating and pressurizing the print medium.

The print media housing unit 140 houses print media used for image formation in the printer unit 130.

The image reading unit 150 reads image information of a reading target as contrasts of light. The image reading unit 150 records the read image information. The recorded image information may be transmitted to other information processing devices via a network. The recorded image information may be imaged on a print medium by the printer unit 130.

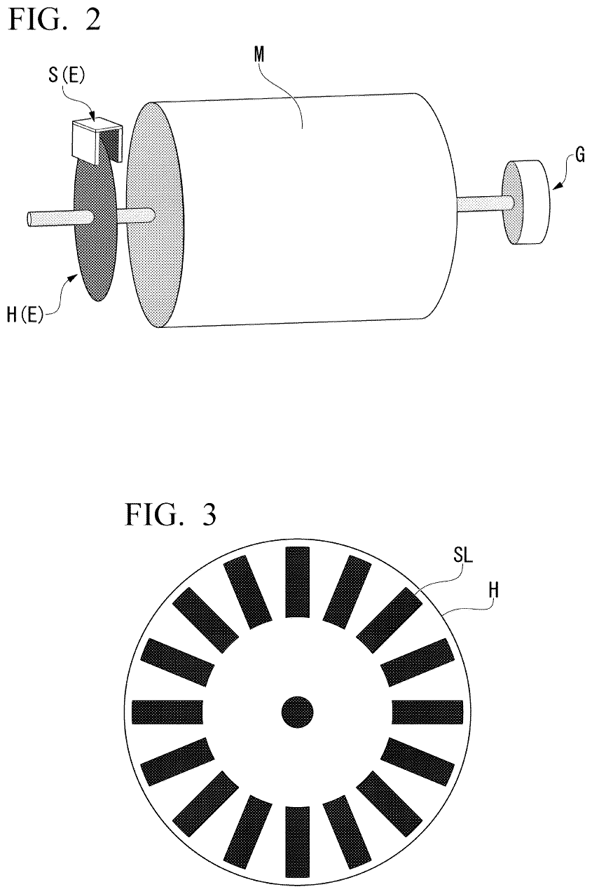

The image forming device 100 has various DC motors inside each of the printer unit 130 and the image reading unit 150. The DC motors included in the image forming device 100 may be, for example, a DC motor that rotates a conveyance roller conveying a print medium inside the printer unit 130, a DC motor that moves other moving parts inside the printer unit 130, and the like. The DC motors included in the image forming device 100 may be, for example, a DC motor that rotates rollers conveying a reading target inside the image reading unit 150, a DC motor that moves other moving parts inside the image reading unit 150, and the like. FIG. 2 is a diagram illustrating an example of a DC motor included in the image forming device 100. The DC motor M illustrated in FIG. 2 is an example of the DC motor included in the image forming device 100. As an example, a case in which the DC motor M is a conveyance motor that rotates conveyance rollers conveying a print medium inside the printer unit 130 is described.

Although the DC motor M is, for example, a servo motor operated using DC power, it may be another motor operated using DC power in place of the servo motor. An optical rotary encoder E is attached to the DC motor M. A gear G is attached to the rotating shaft of the DC motor M. The DC motor M transfers a driving force to the conveyance rollers through a wheel train or the like that is engaged with the gear G.

The optical rotary encoder E has a code wheel H and a transmission-type sensor S.

The code wheel H is a disk-shaped scale. FIG. 3 is an enlarged top view of the code wheel H illustrated in FIG. 2. As illustrated in FIG. 3, in the code wheel H, scales called slits are formed. In FIG. 3, each of multiple slits formed in the code wheel H is denoted by a black rectangle. A slit SL illustrated in FIG. 3 is one of such multiple slits. The code wheel H is attached to a rotary shaft of the DC motor M such that it rotates coaxially with this rotary shaft in accordance with the rotation of the rotary shaft of the DC motor M.

The transmission-type sensor S interposes the code wheel H between a light emitting element and a light receiving element, and the light receiving element detects whether or not light emitted from the light emitting element passes through the slit of the code wheel. The transmission-type sensor S outputs an L-level signal in a case in which light emitted from the light emitting element passes through the slit of the code wheel H and is received by the light receiving element. On the other hand, the transmission-type sensor S outputs a H-level signal in a case in which light emitted from the light emitting element does not pass through the slit of the code wheel H, in other words, in a case in which this light is not received by the light receiving element. For this reason, the transmission-type sensor S outputs a pulse signal corresponding to the rotation of the code wheel H. For convenience of description, the pulse signal output from the transmission-type sensor S is simply referred to as a pulse signal in description. For convenience of description, the width of the pulses included in the pulse signal is referred to as the pulse width of the pulse signal. The pulse width of the pulse signal is determined in accordance with the rotational speed of the code wheel H, that is, the rotational speed of the DC motor M. In other words, the pulse width of the pulse signal corresponds to the rotational speed of the DC motor M with one-to-one correspondence. For this reason, the image forming device 100 can identify the pulse width of the pulse signal based on the rotational speed of the DC motor M.

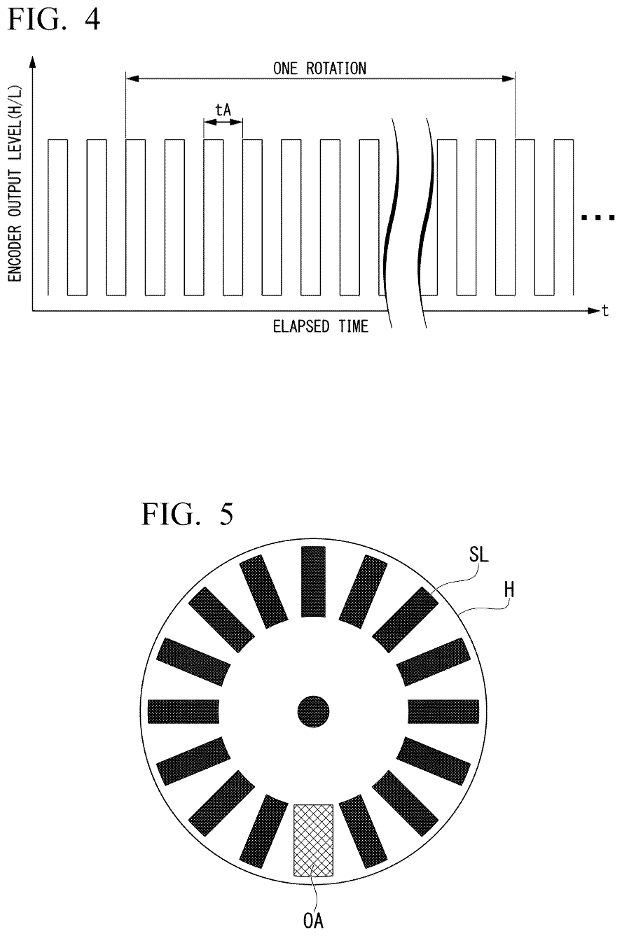

FIG. 4 is a diagram illustrating an example of the pulse signal. A horizontal axis of a graph illustrated in FIG. 4 represents the elapsed time. A vertical axis of this graph represents the level of the pulse signal. In FIG. 4, this level is represented using “encoder output level (H/L)”. In FIG. 4, a pulse output from the transmission-type sensor S while the rotation shaft of the DC motor M rotates once among pulses included in the pulse signal is illustrated. Time tA illustrated in FIG. 4 is the pulse width of the pulse signal illustrated in FIG. 4. For convenience of description, the rotational speed of the DC motor M is simply referred to as a rotational speed. For convenience of description, the rotational speed of a case in which the pulse width is represented by time tA is referred to as a rotational speed V in description.

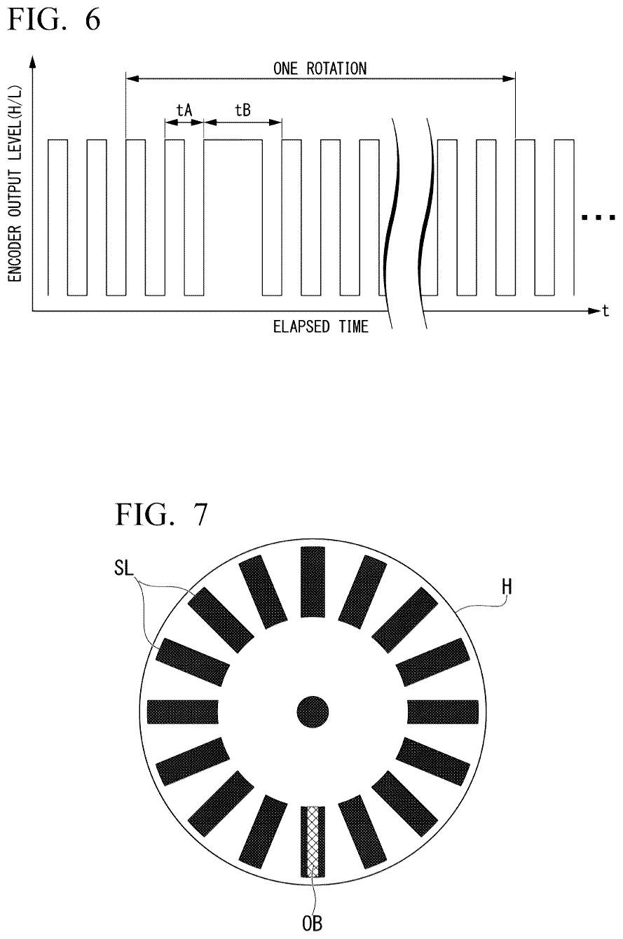

Thus, the pulse width of the pulse signal may change in a case in which a foreign matter has adhered to the code wheel H. For example, as illustrated in FIG. 5, in a case in which a foreign matter is adhering to the code wheel H such that it covers one of the slits of the code wheel H, a pulse signal as represented in FIG. 6 is output from the transmission-type sensor S. For convenience of description, a slit to which a foreign matter is adhering among the slits of the code wheel H is referred to as a foreign matter adhesion slit in description. FIG. 5 is a diagram illustrating an example of the view of the code wheel H to which a foreign matter, which is large enough to cover the foreign matter adhesion slit, is adhering. FIG. 6 is a diagram illustrating an example of the pulse signal of a case in which an object OA is adhering to the foreign matter adhesion slit as illustrated in FIG. 5. The object OA illustrated in FIG. 5 is an example of the foreign matter adhering to the foreign matter adhesion slit. A horizontal axis of the graph illustrated in FIG. 6 represents the elapsed time. A vertical axis of this graph illustrates the level of the pulse signal, similar to the vertical axis of the graph illustrated in FIG. 4. However, in the example illustrated in FIG. 6, the rotational speed of the DC motor M is a rotational speed V.

In a case in which an object OA is adhering to the foreign matter adhesion slit as illustrated in FIG. 5, the transmission-type sensor S regularly outputs a pulse with a pulse width of time tB together with a pulse with a pulse width of time tA. The reason for this is that, in a case in which the foreign matter adhesion slit is covered with the object OA as illustrated in FIG. 5, light emitted from the light emitting unit of the transmission-type sensor S does not pass through the foreign matter adhesion slit. In a case in which this light does not pass through this foreign matter adhesion slit, this light is not received by the light receiving unit until a next slit of this foreign matter adhesion slit passes between the light emitting unit and the light receiving unit. For this reason, in this case, the time tB becomes twice the time tA. In other words, tB=tA*2. In this embodiment, * denotes a multiplication sign. This means that it can be detected whether or not a foreign matter is adhering to the code wheel H in accordance with whether or not a pulse with a pulse width that is twice the pulse width corresponding to the rotational speed or more appears in the pulse signal. More specifically, the image forming device 100 can judge that a foreign matter large enough to cover the foreign matter adhesion slit is adhering to the code wheel H in a case in which such a pulse appears in the pulse signal.

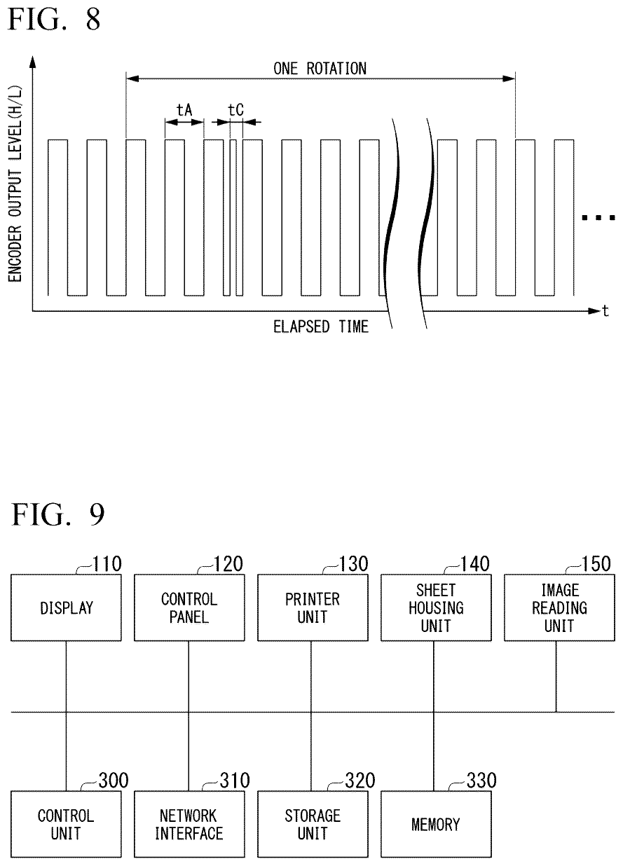

On the other hand, for example, in a case in which a foreign matter is adhering to the code wheel H such that it covers a part of the foreign matter adhesion slit, as illustrated in FIG. 7, a pulse signal as illustrated in FIG. 8 tends to be output from the transmission-type sensor S. FIG. 7 is a diagram that illustrates an example of the view of the code wheel H to which a foreign matter that is small enough to cover only a part of the foreign matter adhesion slit is adhering. FIG. 8 is a diagram illustrating an example of a pulse signal of a case in which an object OB is adhering to the foreign matter adhesion slit as illustrated in FIG. 7. The object OB illustrated in FIG. 7 is an example of a foreign matter covering a part of the foreign matter adhesion slit. A horizontal axis of a graph illustrated in FIG. 8 represents the elapsed time. Similar to the vertical axis of the graph illustrated in FIG. 4, a vertical axis of this graph represents the level of the pulse signal. However, in the example illustrated in FIG. 8, the rotational speed is a rotational speed V.

In a case in which an object OB is adhering to the foreign matter adhesion slit as illustrated in FIG. 7, the transmission-type sensor S regularly outputs a pulse with a pulse width of time tC together with a pulse with a pulse width of time tA. The reason for this is that, in a case in which a part of the foreign matter adhesion slit is covered with the object OB as illustrated in FIG. 7, light emitted from the light emitting unit of the transmission-type sensor S passes through a part of the foreign matter adhesion slit and does not pass through the other part of the foreign matter adhesion slit. Here, in a case in which the size of the foreign matter covering a part of the foreign matter adhesion slit is larger than (½) times the width of the foreign matter adhesion slit, the pulse signal may be a pulse signal as illustrated in FIG. 6. The reason for this is that, in such a case, it is difficult for light emitted from the light emitting unit to pass through the foreign matter adhesion slit. Thus, in such a case, the image forming device 100 can detect whether or not a foreign matter is adhering to the code wheel H in accordance with whether or not a pulse with a pulse width that is twice the pulse width corresponding to the rotational speed or more appears in the pulse signal. On the other hand, in a case in which the size of a foreign matter covering a part of the foreign matter adhesion slit is (½) times the width of the foreign matter adhesion slit, the pulse signal becomes a pulse signal illustrated in FIG. 7. Time tC is (½) times the time tA. In other words, tC=tA*(½). This means that it can be detected whether or not a foreign matter is adhering to the code wheel H in accordance with whether or not a pulse with a pulse width that is (½) times the pulse width corresponding to the rotational speed or less appears in the pulse signal. The reason for this is that, in a case in which the size of a foreign matter covering a part of the foreign matter adhesion slit is less than (½) times the width of the foreign matter adhesion slit, the smallest pulse width appearing in the pulse signal becomes less than (½) times the time tA. Thus, in a case in which a pulse with a pulse width that is (½) times the pulse width corresponding to the rotational speed or less appears in the pulse signal, the image forming device 100 can judge that a foreign matter that is small enough to cover only a part of the foreign matter adhesion slit is adhering to the code wheel H.

As above, the image forming device 100 can judge whether or not a foreign matter is adhering to the code wheel H based on the pulse signal. In order to realize this, the image forming device 100 acquires target speed information representing a target speed for a speed corresponding to the rotational speed and detects whether or not a foreign matter is adhering to the code wheel H based on the acquired target speed information. More specifically, the image forming device 100 calculates a threshold value for the pulse width of the pulse signal based on the acquired target speed information and detects whether or not a foreign matter is adhering to the code wheel H based on the calculated threshold value. The time tB and the time tC described above are examples of such a threshold value. In accordance with this, the image forming device 100 can judge whether or not a foreign matter is adhering to the optical rotary encoder E also at the normal use time of a user without stopping various processes executed by the user. In other words, the image forming device 100 can detect whether or not a foreign matter is adhering to the optical rotary encoder E while suppressing a decrease in user convenience.

### Functional Configuration of Image Forming Device

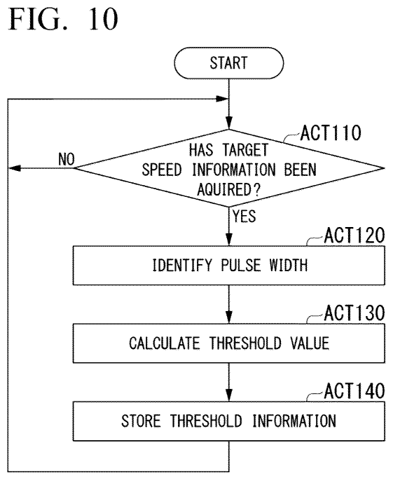

The functional configuration of the image forming device 100 will be described with reference to FIG. 9.

FIG. 9 is a diagram illustrating an example of the functional configuration of the image forming device 100.

The image forming device 100 includes a display 110, a control panel 120, a printer unit 130, a print media housing unit 140, and an image reading unit 150. The image forming device 100 includes a control unit 300, a network interface 310, a storage unit 320, and a memory 330. These functional units included in the image forming device 100 are connected to be able to communicate with each other via a system bus.

Description of the display 110, the control panel 120, the printer unit 130, the print media housing unit 140, and the image reading unit 150 is similar to the description presented above and thus is omitted. Hereinafter, the control unit 300, the network interface 310, the storage unit 320, and the memory 330 are described below.

The control unit 300 is an example of the control unit of the image forming device 100. The control unit 300 is configured to include a Central Processing Unit (CPU) of the image forming device 100. The control unit 300 controls the operation of each functional unit of the image forming device 100. The control unit 300 executes various processes by executing programs. The control unit 300 acquires instructions input by a user from the control panel 120. In other words, the control unit 300 receives operations from a user using the control panel 120. The control unit 300 executes a control process based on an acquired instructions. The control unit 300 may be configured to include other processors such as a Field Programmable Gate Array (FPGA) in place of the CPU.

The network interface 310 transmits/receives data to/from other devices. The network interface 310 operates as an input interface and receives data transmitted from other devices. In addition, the network interface 310 operates as an output interface and transmits data to other devices.

The storage unit 320, for example, is an auxiliary storage device such as a hard disk, a Solid State Drive (SSD), or the like. The storage unit 320 stores various types of information. For example, the storage unit 320 stores programs to be executed by the control unit 300. These programs are, for example, firmware, applications, and the like.

The memory 330 is, for example, a Random Access Memory (RAM). The memory 330 temporarily stores information used by each functional unit included in the image forming device 100. The memory 330 may store image information read by the image reading unit 150, programs that operate each functional unit, and the like.

### Process of Calculating Threshold Value for Detecting Whether or Not Foreign Matter is Adhering to Optical Rotary Encoder Using Image Forming Device

The process in which the image forming device 100 calculates a threshold value for detecting whether or not a foreign matter is adhering to the optical rotary encoder E is described with reference to FIG. 10. For convenience of description, the threshold value used for detecting whether or not a foreign matter is adhering to the optical rotary encoder E is simply referred to as a judgment threshold value. FIG. 10 is a diagram illustrating an example of the flow of a process in which the image forming device 100 calculates the judgment threshold value. In other words, FIG. 10 illustrates an example of the flow of the process executed by the image forming device 100 for the DC motor M. The process of the flowchart illustrated in FIG. 10 may be applied to at least some of DC motors among DC motors included in the image forming device 100 other than the DC motor M. For example, in a case in which the power of the image forming device 100 becomes on, the image forming device 100 continues to execute the process of the flowchart illustrated in FIG. 10 until the power of the image forming device 100 becomes off.

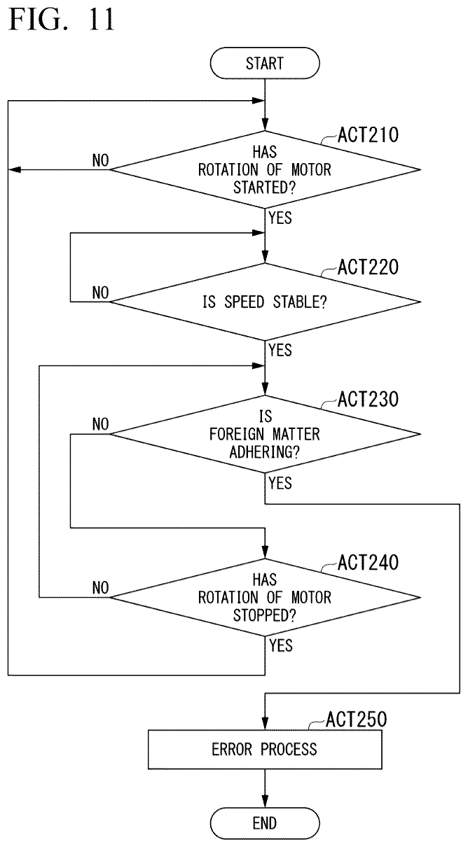

The control unit 300 waits until it acquires target speed information representing a target speed for the speed corresponding to the rotational speed (ACT110). This speed may be the rotational speed itself, a conveyance speed of a print medium conveyed in accordance with the rotation of the DC motor M, or any other speed according to the rotation of the DC motor M. As an example, a case in which this speed is the rotational speed is described. In a case in which the control unit 300 acquires the target speed information, the control unit begins to rotate the DC motor M and starts feedback control of the DC motor M such that the rotational speed becomes closer to the rotational speed represented by the target speed information in accordance with a process different from the process of the flowchart illustrated in FIG. 11.

In a case in which it is judged that the target speed information has been acquired (ACT110—Yes), the control unit 300 identifies a pulse width corresponding to a target speed represented by the target speed information acquired as the pulse width of the pulse signal (ACT120). The time tA described above is an example of the pulse width corresponding to the target speed in a case in which the target speed is the rotational speed V. For convenience of description, the pulse width calculated in ACT120 is referred to as a target pulse width in description. For example, the control unit 300 may be configured to perform the process of ACT120 based on a function that calculates the pulse width corresponding to the target speed by substituting the target speed. For example, the control unit 300 may be configured to perform the process of ACT120 based on correspondence information in which a target speed and a pulse width corresponding to the target speed are associated with each other. In such a case, the correspondence information is stored in the storage unit 320 in advance. The control unit 300 may be configured to perform the process of ACT120 using another method.

Next, the control unit 300 calculates a judgment threshold value based on the target pulse width (ACT130). More specifically, the control unit 300 calculates a pulse width that is twice the target pulse width as a first threshold value in ACT130. The first threshold value is a threshold value for detecting a foreign matter larger than the slit width of the code wheel H. On the other hand, the control unit 300 calculates a pulse width that is (½) times the target pulse width as a second threshold value in ACT130. The second threshold value is a threshold value for detecting a foreign matter smaller than the slit width of the code wheel H. In other words, two threshold values including the first threshold value and the second threshold value are included in the judgment threshold value calculated in ACT130 by the control unit 300. The time tB described above is an example of the first threshold value. The time tC described above is an example of the second threshold value.

Next, the control unit 300 stores threshold information representing each of two threshold values calculated as judgment threshold values in ACT130 in the storage unit 320 (ACT140). After the process of ACT140 is performed, the control unit 300 causes the process to proceed to ACT110 and waits again until the target speed information representing a target speed for a speed corresponding to the rotational speed is acquired. In other words, the image forming device 100 calculates the judgment threshold value each time the target speed information is acquired. Here, as mentioned above, the rotational speed corresponds one-to-one with the pulse width of the pulse signal. For this reason, the image forming device 100 calculates different threshold values in a case in which target speed information representing a first target speed is acquired as the target speed and in a case in which target speed information representing a second target speed is acquired as the target speed. Here, the second target speed is a target speed that is different from the first target speed.

In a case in which it is judged that the target speed information has been acquired in the process of ACT110 described above and in a case in which a target speed represented by the acquired target speed information is changing, the control unit 300 may be configured to perform the process of ACT120 and subsequent processes. In such a case, the control unit 300 calculates the judgment threshold value each time the target speed represented by the acquired target speed information changes.

As above, in a case in which the target speed information has been acquired, the image forming device 100 can calculate the judgment threshold value based on the acquired target speed information. As a result, the image forming device 100 can detect whether or not a foreign matter is adhering to the code wheel H based on the calculated judgment threshold value.

### Process of Detecting Whether or Not Foreign Matter is Adhering to Optical Rotary Encoder Using Image Forming Device

A process in which the image forming device 100 detects whether or not a foreign matter is adhering to the optical rotary encoder E is described with reference to FIG. 11. FIG. 11 is a diagram illustrating an example of the flows of a process in which the image forming device 100 detects whether or not a foreign matter is adhering to the optical rotary encoder E. The process of the flowchart illustrated in FIG. 11 may be applied to at least some of DC motors among DC motors included in the image forming device 100 other than the DC motor M. For example, in a case in which the power of the image forming device 100 is on, the image forming device 100 continues to execute the process of the flowchart illustrated in FIG. 11 until the power of the image forming device 100 becomes off.

The control unit 300 waits until the DC motor M begins to rotate (ACT210). In FIG. 11, the process of ACT110 is represented using “Has rotation of motor started?”. A method in which the control unit 300 performs the process of ACT210 may be a known method or a method that will be developed in the future.

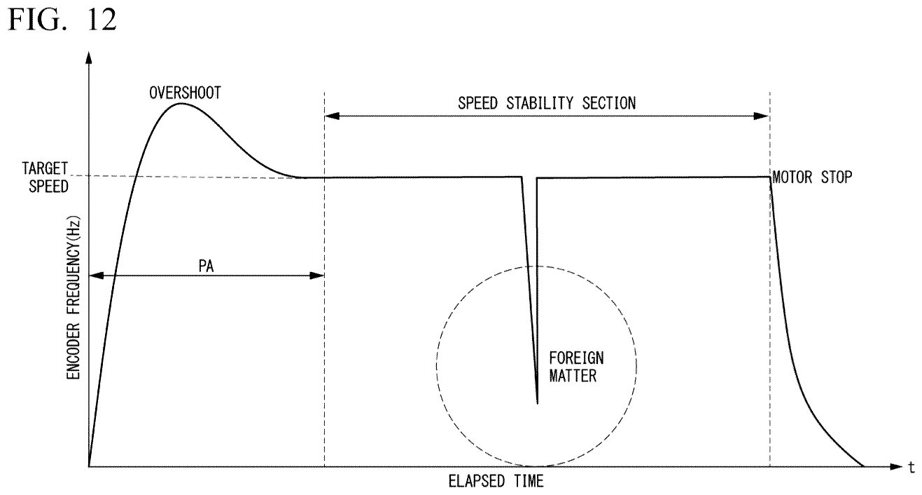

In a case in which it is judged that the DC motor M has begun to rotate (ACT210—Yes), the control unit 300 starts to acquire a pulse signal from the transmission-type sensor S and waits until the rotational speed stabilizes based on the acquired pulse signal (ACT220). This means that the control unit 300 executes the process of ACT230 and subsequent processes within a speed stability section. FIG. 12 is a diagram illustrating the speed stability section. A horizontal axis of the graph illustrated in FIG. 12 represents the elapsed time. A vertical axis of this graph represents the frequency of the pulse signal. In FIG. 12, the frequency of the pulse signal is represented using “encoder frequency”. When the control unit 300 tries to rotate the DC motor M such that the rotational speed matches the target speed, the frequency of the pulse signal changes over time, for example, along a curve illustrated in FIG. 12. In other words, the frequency of the pulse signal overshoots in a section PA in which the DC motor M begins to rotate. The reason for this is that the rotational speed temporarily exceeds the target speed according to feedback control of the DC motor M in the section PA. Even if a change in the pulse width of the pulse signal occurs in the section PA, it is difficult to distinguish this change from a change due to overshoot. On the other hand, after the section PA, the rotational speed stabilizes. In other words, a section represented by “speed stability section” in FIG. 12 is a section in which the rotational speed is stable except for fluctuations due to noise, vibration, and the like. In a case in which the pulse width of the pulse signal changes in the speed stability section, the control unit 300 can accurately detect that the pulse width of the pulse signal has changed. In FIG. 12, such a change in the frequency of the pulse signal according to a change in the pulse width of the pulse signal is represented in accordance with a drop in the frequency of the pulse signal within the speed stability section. Such a speed stability section continues until the rotation of the DC motor M stops. Thus, after the section PA until the rotation of the DC motor M is stopped, the control unit 300 judges whether or not a foreign matter is adhering to the optical rotary encoder E. A method in which the control unit 300 judges whether or not the rotational speed has stabilized is, for example, a judgment method based on whether or not the frequency of the pulse signal acquired by the control unit 300 has not changed for a predetermined time or longer, but the method is not limited thereto.

In a case in which it is judged that the rotational speed has stabilized (ACT220—Yes), the control unit 300 judges whether or not a foreign matter is adhering to the optical rotary encoder E based on the acquired pulse signal (ACT230). The process of ACT230 process is described below.

The control unit 300 performs the following process as the process of ACT230. The control unit 300 reads threshold information representing the judgment threshold value calculated in the process of the flowchart illustrated in FIG. 10 from the storage unit 320. After reading the threshold information, the control unit 300 performs two judgments including judging whether or not a pulse with a pulse width that is the first threshold value represented by the readout threshold information or more appears in the acquired pulse signal and judging whether or not a pulse with a pulse width that is the second threshold value represented by the readout threshold information or less appears in the acquired pulse signal. In a case in which it is judged that a pulse with a pulse width that is the first threshold value represented by the readout threshold information or more has appeared, the control unit 300 judges that a foreign matter is adhering to the optical rotary encoder E. More specifically, in this case, the control unit 300 judges that a foreign matter larger than the slit width of the slit of the code wheel H is adhering to the code wheel H. On the other hand, also in a case in which it is judged that a pulse with a pulse width that is the second threshold value represented by the readout threshold information or less has appeared, the control unit 300 judges that a foreign matter is adhering to the optical rotary encoder E. More specifically, in this case, the control unit 300 judges that a foreign matter smaller than the slit width of the slit of the code wheel H is adhering to the code wheel H. In a case in which it is judged that a pulse with a pulse width that is the first threshold value represented by the readout threshold information or more has not appeared and in a case in which a pulse with a pulse width that is the second threshold value represented by the readout threshold information or less has not appeared, the control unit 300 judges that no foreign matter is adhering to the optical rotary encoder E. The control unit 300 performs the process as described above as the process of ACT230.

In a case in which it is judged that no foreign matter is adhering to the optical rotary encoder E (ACT230—No), the control unit 300 judges whether or not the rotation of the DC motor M has stopped (ACT240). A method in which the control unit 300 judges whether or not the rotation of the DC motor M has stopped may be a known method or a method that will be developed in the future.

In a case in which it is judged that the rotation of the DC motor M has not stopped (ACT240—No), the control unit 300 causes the process to proceed to ACT230 and judges again whether or not a foreign matter is adhering to the optical rotary encoder E.

On the other hand, in a case in which it is judged that the rotation of the DC motor M has stopped (ACT240—Yes), the control unit 300 causes the process to proceed to ACT210 and waits again until the DC motor M begins to rotate.

On the other hand, in a case in which it is judged that a foreign matter is adhering to the optical rotary encoder E (ACT230—YES), an error process is performed (ACT250). The error process is a process that is executed by the control unit 300 in accordance with adhesion of a foreign matter to the optical rotary encoder E. The error process may include, for example, a process of notifying other devices of adhesion of a foreign matter to the code wheel H. These other devices are a service personnel contracted to perform maintenance of the image forming device 100, a personal computer (PC) of a company, and the like, but are not limited thereto. The error process may include, for example, a process of displaying information urging a user to remove a foreign matter adhering to the code wheel H on the display 110. The error process may include, for example, a process of stopping the rotation of the DC motor M. The error process may include, for example, a process of stopping the formation of an image on the print medium. The error process may include, for example, a process of displaying information indicating that a foreign matter is adhering to the optical rotary encoder E on the display 110. The error process may include, for example, a process of identifying a slit to which a foreign matter is estimated to adhere among slits of the code wheel H as a foreign matter adhesion slit and stopping the DC motor M such that the position of the identified foreign matter adhesion slit is located at a position determined in advance. The position determined in advance may be any position as long as it is a position at which it is easy for a person cleaning the code wheel H such as a service person undertaking maintenance of the image forming device 100 to remove the foreign matter. This position determined in advance is, for example, a position on a side opposite to the position of the transmission-type sensor S with the central axis of the code wheel H interposed therebetween, but is not limited thereto. The error process may be configured to include other processes in place of at least one of these processes or in addition to all of these processes. After the process of ACT250, the control unit 300 ends the process of the flowchart illustrated in FIG. 11.

As described above, the image forming device 100 can detect whether or not a foreign matter is adhering to the code wheel H based on the judgment threshold value calculated based on the target speed information representing a target speed for a speed corresponding to the rotational speed of the DC motor. As a result, the image forming device 100 can determine whether or not a foreign matter is adhering to the optical rotary encoder E without stopping various processes executed by a user. In other words, the image forming device 100 can detect whether or not a foreign matter is adhering to the optical rotary encoder E while suppressing a decrease in user convenience.

The items described above may be combined in any way.

The target speed described above may, for example, be substituted with a target value for the duty ratio of a Pulse Width Modulation (PWM) signal supplied to the DC motor M in a case in which the DC motor M is controlled using open loop control. In such a case, the image forming device 100, for example, identifies the pulse width of the pulse signal based on this target value in ACT120.

### Supplementary Note

[1]

An image forming device including: an optical rotary encoder having a code wheel; a DC motor to which the optical rotary encoder is attached; and a control unit controlling the DC motor, in which the control unit acquires target speed information representing a target speed for a speed corresponding to a rotational speed of the DC motor and detects whether or not a foreign matter is adhering to the code wheel based on the acquired target speed information.

[2]

The image forming device described in [1], in which the control unit calculates a threshold value for a pulse width of a pulse signal output from the optical rotary encoder based on the target speed information and detects whether or not a foreign matter is adhering to the code wheel based on the calculated threshold value.

[3]

The image forming device described in [2], in which the threshold value includes a first threshold value used for detecting a foreign matter larger than a slit width of the code wheel and a second threshold value used for detecting a foreign matter smaller than the slit width of the code wheel, and the control unit judges that a foreign matter larger than the slit width of the code wheel is adhering to the code wheel in a case in which the pulse width that is the first threshold value or more is output from the optical rotary encoder and judges that a foreign matter smaller than the slit width of the code wheel is adhering to the code wheel in a case in which the pulse width that is the second threshold value or less is output from the optical rotary encoder.

[4]

The image forming device described in [2] or [3], in which the control unit calculates different threshold values in a case in which the target speed information representing a first target speed as the target speed is acquired and a case in which the target speed information representing a second target speed as the target speed is acquired.

[5]

The image forming device described in any one of [2] to [4], in which the control unit calculates the threshold value each time the target speed represented by the acquired target speed information changes.

[6]

The image forming device described in any one of [1] to [5], in which the control unit performs a process corresponding to adhesion of a foreign matter to the code wheel in a case in which it is detected that a foreign matter is adhering to the code wheel.

[7]

The image forming device described in [6], in which the process includes a process of notifying other devices that a foreign matter is adhering to the code wheel.

[8]

The image forming device described in [6] or [7], in which the process includes a process of identifying a slit to which a foreign matter is estimated to adhere among slits of the code wheel as a foreign matter adhesion slit and stopping the DC motor such that a position of the identified foreign matter adhesion slit is located at a position determined in advance.

While several embodiments of the present invention have been described, such embodiments are presented as examples and are not intended to limit the scope of the invention. These embodiments can be performed in other various forms, and various additions, omissions, substitutions, and other modifications can be made without departing from the spirit or scope of the invention. Accordingly, these embodiments and the modifications thereof, similar to a case of being included in the scope or the concept of the invention, are included in the invention described in the claims and the scope of equivalency thereof.

In addition, a program for realizing the function of an arbitrary constituent unit of the device described above (for example, the image forming device 100 or the like) may be recorded on a computer-readable recording medium, and a computer system may be caused to read and execute the program. A “computer system” described here includes an OS and hardware such as peripheral devices. A “computer-readable recording medium” represents a storage device including a portable medium such as a flexible disk, a magneto-optical disc, a ROM, or a Compact Disk (CD)-ROM, a hard disk built in a computer system, and the like. The “computer-readable recording medium” includes a server in a case in which a program is transmitted through a network such as the Internet or a communication line such as a telephone line or a device such as a volatile memory (RAM) disposed inside a computer system that serves as a client that stores a program for a predetermined time.

The program described above may be transmitted from a computer system storing this program in a storage device or the like to another computer system through a transmission medium or a transmission wave in a transmission medium. The “transmission medium” transmitting a program represents a medium having an information transmitting function such as a network (communication network) including the Internet and the like or a communication line (communication wire) including a telephone line.

The program described above may be used for realizing a part of the functions described above. The program described above may be a program realizing the functions described above by being combined with a program recorded in the computer system in advance, a so-called a differential file (differential program).

### EXPLANATION OF REFERENCES

100 Image forming device
110 Display
120 Control panel
130 Printer unit
140 Print media housing unit
150 Image reading unit
300 Control unit
310 Network interface
320 Storage unit
330 Memory
E Optical rotary encoder
G gear
H code wheel
M DC motor
OA, OB Object
S Transmission-type sensor
SL slit

What is claimed is:

1. An image forming device comprising:
an optical rotary encoder having a code wheel;
a DC motor to which the optical rotary encoder is attached; and
a control unit controlling the DC motor,
wherein the control unit acquires target speed information representing a target speed for a speed corresponding to a rotational speed of the DC motor and detects whether or not a foreign matter is adhering to the code wheel based on the acquired target speed information.

2. The image forming device according to claim 1, wherein the control unit calculates a threshold value for a pulse width of a pulse signal output from the optical rotary encoder based on the target speed information and detects whether or not a foreign matter is adhering to the code wheel based on the calculated threshold value.

3. The image forming device according to claim 2,
wherein the threshold value includes a first threshold value used for detecting a foreign matter larger than a slit width of the code wheel and a second threshold value used for detecting a foreign matter smaller than the slit width of the code wheel, and
the control unit judges that a foreign matter larger than the slit width of the code wheel is adhering to the code wheel in a case in which the pulse width that is the first threshold value or more is output from the optical rotary encoder and judges that a foreign matter smaller than the slit width of the code wheel is adhering to the code wheel in a case in which the pulse width that is the second threshold value or less is output from the optical rotary encoder.

4. The image forming device according to claim 2, wherein the control unit calculates different threshold values in a case in which the target speed information representing a first target speed as the target speed is acquired and a case in which the target speed information representing a second target speed as the target speed is acquired.

5. The image forming device according to claim 3, wherein the control unit calculates different threshold values in a case in which the target speed information representing a first target speed as the target speed is acquired and a case in which the target speed information representing a second target speed as the target speed is acquired.

6. The image forming device according to claim 2, wherein the control unit calculates the threshold value each time the target speed represented by the acquired target speed information changes.

7. The image forming device according to claim 3, wherein the control unit calculates the threshold value each time the target speed represented by the acquired target speed information changes.

8. The image forming device according to claim 4, wherein the control unit calculates the threshold value each time the target speed represented by the acquired target speed information changes.

9. The image forming device according to claim 5, wherein the control unit calculates the threshold value each time the target speed represented by the acquired target speed information changes.

10. The image forming device according to claim 1, wherein the control unit performs a process corresponding to adhesion of a foreign matter to the code wheel in a case in which it is detected that a foreign matter is adhering to the code wheel.

11. The image forming device according to claim 2, wherein the control unit performs a process corresponding to adhesion of a foreign matter to the code wheel in a case in which it is detected that a foreign matter is adhering to the code wheel.

12. The image forming device according to claim 3, wherein the control unit performs a process corresponding to adhesion of a foreign matter to the code wheel in a case in which it is detected that a foreign matter is adhering to the code wheel.

13. The image forming device according to claim 4, wherein the control unit performs a process corresponding to adhesion of a foreign matter to the code wheel in a case in which it is detected that a foreign matter is adhering to the code wheel.

14. The image forming device according to claim 5, wherein the control unit performs a process corresponding to adhesion of a foreign matter to the code wheel in a case in which it is detected that a foreign matter is adhering to the code wheel.

15. The image forming device according to claim 6, wherein the control unit performs a process corresponding to adhesion of a foreign matter to the code wheel in a case in which it is detected that a foreign matter is adhering to the code wheel.

16. The image forming device according to claim 7, wherein the control unit performs a process corresponding to adhesion of a foreign matter to the code wheel in a case in which it is detected that a foreign matter is adhering to the code wheel.

17. The image forming device according to claim 8, wherein the control unit performs a process corresponding to adhesion of a foreign matter to the code wheel in a case in which it is detected that a foreign matter is adhering to the code wheel.

18. The image forming device according to claim 9, wherein the control unit performs a process corresponding to adhesion of a foreign matter to the code wheel in a case in which it is detected that a foreign matter is adhering to the code wheel.

19. The image forming device according to claim 10, wherein the process includes a process of notifying other devices that a foreign matter is adhering to the code wheel.

20. The image forming device according to claim 10, wherein the process includes a process of identifying a slit to which a foreign matter is estimated to adhere among slits of the code wheel as a foreign matter adhesion slit and stopping the DC motor such that a position of the identified foreign matter adhesion slit is located at a position determined in advance.
